(19) United States
(12) Patent Application Publication
(10) Pub. No.: US 2019/0197578 A1
(43) Pub. Date: Jun. 27, 2019

(54) GENERATING SIGNIFICANT PERFORMANCE INSIGHTS ON CAMPAIGNS DATA

(71) Applicant: c/o Datorama Technologies, Ltd., Tel-Aviv (IL)

(72) Inventors: Uri SHERMAN, Tel Aviv (IL); Yonatan GINAT, Yahud (IL); Amir KAFRI, Tel Aviv (IL)

(73) Assignee: c/o Datorama Technologies, Ltd., Tel-Aviv (IL)

(21) Appl. No.: 15/854,381

(22) Filed: Dec. 26, 2017

(51) Int. Cl. G06Q 30/02; G06F 17/18; G06F 15/18

(52) U.S. Cl. CPC G06Q 30/0244; G06F 15/18; G06F 17/18

(57) ABSTRACT

A system and method for providing significant performance insights on marketing campaign data. The method includes training a regression model using a training set including segments and corresponding performance metrics of a plurality of potentially significant insights, each segment being a combination of a dimension and a value, wherein each insight includes a segment and a corresponding performance metric; filtering, based on the regression model, at least one insight from the plurality of potentially significant insights to result in at least one significant insight; computing, based in part on the regression model, a total significance score for each of the at least one significant insight; and ranking the at least one significant insight based on the computed total significance scores.

### TECHNICAL FIELD

The present disclosure relates generally to performance data, and more particularly to utilizing machine learning techniques to analyze performance data of marketing campaigns.

### BACKGROUND

Entities looking to improve performance in order to remain competitive often seek to evaluate performance metrics to identify strengths, weaknesses, issues, and the like. In particular, in the context of Internet traffic and advertising, performance metrics such as click-through rate, cost per acquisition (CPA), bounce rate, and qualified leads ratio are analyzed to determine effectiveness of website performance with respect to content, layout, advertisements, and the like.

Effectiveness of performance has traditionally been analyzed by human operators such as project managers. However, human operators cannot analyze raw data for many types of performance metrics, particularly performance metrics related to websites that are visited thousands or millions of times per day. Although some automated solutions for analyzing performance metrics exist, such solutions are typically preconfigured to analyze performance based on preset rules. Additionally, although machine learning and statistical solutions for adaptively analyzing performance exist, these solutions face challenges in identifying factors that significantly affect performance. Accordingly, such solutions often fail to accurately identify key factors in performance, particularly when fluctuations in performance occur over time.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for providing significant performance insights on marketing campaign data. The method comprises: training a regression model using a training set including segments and corresponding performance metrics of a plurality of potentially significant insights, each segment being a combination of a dimension and a value, wherein each insight includes a segment and a corresponding performance metric; filtering, based on the regression model, at least one insight from the plurality of potentially significant insights to result in at least one significant insight; computing, based in part on the regression model, a total significance score for each of the at least one significant insight; and ranking the at least one significant insight based on the computed total significance scores.

Certain embodiments disclosed herein also include a non-transitory computer readable medium having stored thereon causing a processing circuitry to execute a process, the process comprising: training a regression model using a training set including segments and corresponding performance metrics of a plurality of potentially significant insights, each segment being a combination of a dimension and a value, wherein each insight includes a segment and a corresponding performance metric; filtering, based on the regression model, at least one insight from the plurality of potentially significant insights to result in at least one significant insight; computing, based in part on the regression model, a total significance score for each of the at least one significant insight; and ranking the at least one significant insight based on the computed total significance scores.

Certain embodiments disclosed herein also include a system for providing significant performance insights on marketing campaign data. The system comprises: a processing circuitry; and a memory, the memory containing instructions that, when executed by the processing circuitry, configure the system to: train a regression model using a training set including segments and corresponding performance metrics of a plurality of potentially significant insights, each segment being a combination of a dimension and a value, wherein each insight includes a segment and a corresponding performance metric; filter, based on the regression model, at least one insight from the plurality of potentially significant insights to result in at least one significant insight; compute, based in part on the regression model, a total significance score for each of the at least one significant insight; and rank the at least one significant insight based on the computed total significance scores.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is an insight generator according to an embodiment.

FIG. 3 is a flow diagram illustrating a training phase for training a regression model according to an embodiment.

FIG. 4 is a flowchart illustrating a method for providing performance insights according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for providing performance insights. Insights are generated, where each insight includes a segment and a corresponding performance metric value. Each segment is a combination of a dimension and a value for the dimension. The insights may be filtered in a preliminary significance testing phase in which statistical significance scores are computed for each insight. The insights may further be filtered in a regression modeling stage in which a regression model is trained using supervised machine learning of a training set including segment independent variables and corresponding performance metric dependent variables. The insights remaining after the filtering are determined to be significant insights. A total significance score is determined for each significant insight. The significant insights may be ranked using the determined total significance scores.

The total significance score for an insight is determined based on multiple parameters including, but not limited to, a statistical significance score, a predictive score, a size of effect (or effect size) for a performance metric, and a magnitude. To this end, the disclosed embodiments provide techniques for generating statistical significance and predictive scores to increase accuracy and efficiency of the total significance score determination. In particular, the data may be aggregated iteratively with respect to single dimensional segments, multi-dimensional segments, or a combination thereof, in order to determine volume measurements and performance metrics for each insight, and the predictive score may be determined by training a regression model using appropriate features as described further herein below.

The embodiments disclosed herein provide accurate identifications of significant factors in performance of at least marketing campaigns. Further, the embodiments disclosed herein include various techniques for increasing efficiency of identifying the significant factors with respect to at least computing time and numbers of computations.

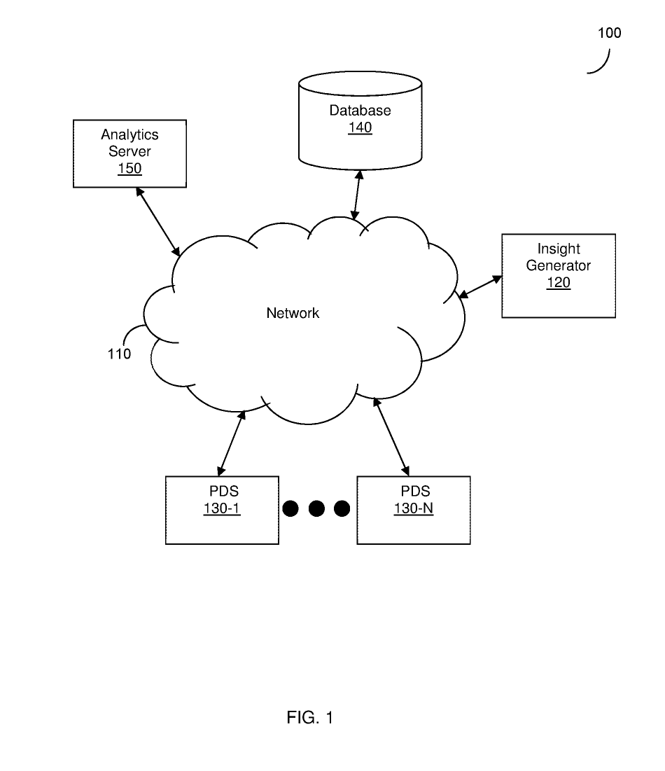

FIG. 1 shows an example network diagram 100 utilized to describe the various disclosed embodiments. The network diagram 100 includes an insight generator 120, one or more performance data sources (PDSs) 130-1 through 130-N (hereinafter referred to individually as a performance data source 130 and collectively as performance data sources 130, merely for simplicity purposes), a database 140, and an analytics server 150 communicatively connected over a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The performance data sources 130 may be local or cloud-based data sources that store performance data. To this end, the performance data sources 130 may be operated by providers of performance data collection services. In some implementations, the performance data sources 130 may include data warehouses such as PostgreSQL, Amazon® Redshift, Google® BigQuery, Presto, AWS® Athena, and the like.

The performance data includes measurements related to effectiveness of performance such as, but not limited to, performance measurements (i.e., measurements of success of content) and volume measurements (i.e., measurements of appearances of content). The performance measurements may include, but are not limited to, number of clicks, number of conversions, number of bounces, number of qualified leads, and the like. The volume measurements may include, but are not limited to, number of impressions, cost (e.g., media cost), number of visits, number of leads, number of platforms on which content is published, number of websites on which content is published, and the like.

The performance data may further include identifiers of factors which may affect performance such as, but not limited to, names (e.g., company names), subject matter of the content (e.g., “good morning,” “sunny day,” “pets,” “family life,” etc.), target audiences (e.g., “children,” “Baby Boomers,” “Millennials,” “ages 35-44,” “women,” “men ages 18-40,” etc.), information about collection of the performance data (e.g., a geographic location of display of advertisements, time periods in which performance data was collected, etc.), characteristics of the content (e.g., quality of the content), a platform on which content was published (e.g., Twitter®, YouTube®, etc.), parameters of a website on which content was published (e.g., execution parameters for the website), a combination thereof, and the like

The performance data may be organized into segments, where each segment includes a dimension (e.g., number of conversions, cost, or target audience) and a corresponding value (e.g., 10 conversions, 330 USD, or “Millennials,” respectively). As a non-limiting example, a segment may include the dimension “geographic location of display” and the value “Germany” such that the aggregated data for that segment includes performance data for advertisements displayed to users in Germany.

At least a portion of the performance data may be utilized to derive performance metrics that represent contextualized indicators of performance (e.g., key performance indicators) such as, but not limited to, click-through rate (CTR) (number of clicks/number of impressions), cost per acquisition (CPA) (media cost/number of conversions), bounce rate (number of bounces/number of visits), qualified leads ratio (number of qualified leads/total number of leads), and the like.

The analytics server 150 may be configured to integrate data from different performance data sources 130. To this end, the analytics server 150 is configured to query, filter, and otherwise prepare data for use by the insight generator 120. Specifically, the analytics server 150 may be configured to normalize data from the different performance data sources 130 (e.g., by cleaning, classifying, or both), to filter data to limit the scope of analysis, both, and the like. For example, monetary values for cost may be normalized such that values in US Dollars (USD) and in Euros can be compared.

The analytics server 150 may further be configured to perform data integration including alteration, classification, or segmentation of data, or a combination thereof. Example data integration techniques are described further in U.S. patent application Ser. No. 14/077,951, assigned to the common assignee, the contents of which are hereby incorporated by reference.

In an embodiment, at least a portion of the data is aggregated with respect to segments, where each segment is a combination of a dimension and value. Thus, the performance data may be analyzed with respect to single dimensional segments or multi-dimensional segments. Example segments include, but are not limited to, a dimension “site” having the value “ESPN,” a dimension “creative” having the value “300×250 rich execution,” a dimension “audience” having a value “millennials,” and a dimension “country” having a value “Germany.” A non-limiting example multi-dimensional segment may be the combination of the dimension “audience” having a value “millennials” with the dimension “country” having a value “Germany.” In an embodiment, data may be initially aggregated with respect to single dimensional segments, and may be subsequently aggregated with respect to multi-dimensional segments, additional single dimensional segments, or both, using segments of significant insights as described herein.

In an embodiment, the insight generator 120 is configured to receive or retrieve data from the analytics server 150, and to generate insights based on the received or retrieved data. Each insight includes a combination of a segment and a performance metric (e.g., a KPI) such that the insight represents a relationship between the segment and the performance metric.

In an embodiment, the insight generator 120 is configured to surface significant insights. More specifically, segments that significantly affect corresponding performance metric values among the insights may be determined. Significant insights may be ranked, and indications of the rankings may be provided. To this end, insights may be filtered to remove insignificant insights, and a total significance score may be determined for each remaining significant insight. The filtering allows for more efficient determination of significance metrics, as significance metrics are only determined for insights that are significant as determined by the filtering. The filtering may include a preliminary significance testing filtering stage and a regression-based filtering stage.

In an embodiment, generating the insights may include a filtering stage in which preliminary significance testing is performed. To this end, the insight generator 120 may be configured to compute statistical significance scores for all of the insights during a preliminary significance testing phase, where insights having statistical significance scores below a threshold are filtered out.

In an embodiment, generating the insights may include a regression-based filtering stage during which a regression model is trained using machine learning regression modeling techniques and predictive scores are generated based on the regression model. To this end, the insight generator 120 is configured to train a regression model using a training set including independent variables and a dependent variable included in the insights. The independent variables include segments, and the dependent variable includes corresponding performance metrics such as key performance indicator (KPI). The regression model may be trained to output predicted KPI values based on input segments. In an embodiment, the regression model is created using random forest regression modeling techniques.

In an embodiment, the insight generator 120 may be configured to rank significant insights (i.e., insights which were not filtered out during a filtering phase). To this end, the insight generator 120 may be configured to generate a total significance score for each insight. Each total significance score represents a degree to which the segment of the insight affects the corresponding performance metric. The effect of the segment on the corresponding performance metric may be further expressed as a positive or negative value.

In an embodiment, the insight generator 120 is configured to generate each total significance score based on a predictive score, a performance metric effect size, a magnitude, and a scaled statistical significance score. The insights may be ranked based on their respective total significance scores.

In an embodiment, the insight generator 120 is configured to aggregate data with respect to the significant insights (e.g., remaining after filtering including the regression filtering), and to compute the scaled statistical significance scores for the significant insights. Accordingly, the scaled significance scores may be computed more efficiently than without such filtering because of reduced runtime complexity due to a lower total amount of data that must be analyzed. In some implementations, the aggregation may be performed with respect to single dimension metrics, double dimension metrics, or a combination thereof. The aggregation may further be performed iteratively.

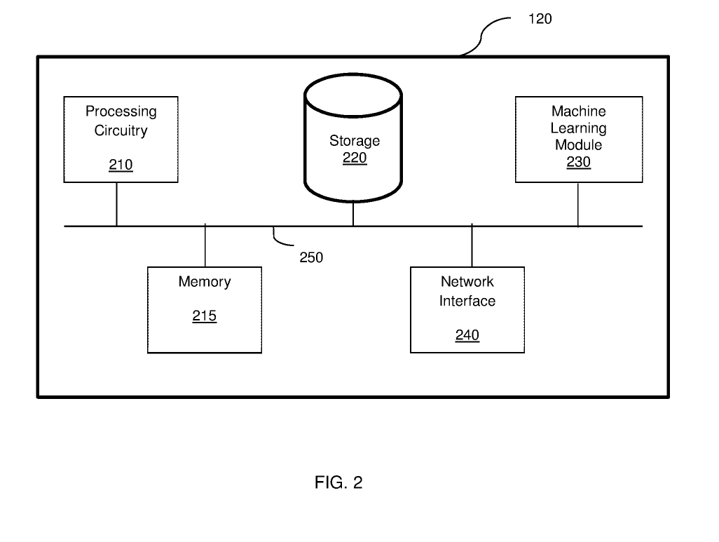

FIG. 2 is an example schematic diagram of the insight generator 120 according to an embodiment. The insight generator 120 includes a processing circuitry 210 coupled to a memory 215, a storage 220, a machine learning processor 230, and a network interface 240. In an embodiment, the components of the insight generator 120 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The machine learning processor 230 is configured to train regression models to be utilized for determining predictive scores for segments based on performance data. The inputs utilized to train the regression models may include segments and corresponding performance metrics. The machine learning model may be configured to perform random forest regression modeling.

The network interface 240 allows the insight generator 120 to communicate with the performance data sources 130, the database 140, the analytics server 150, or a combination of, for the purpose of, for example, receiving and retrieving performance data.

It should be understood that the embodiments described herein are not limited to the specific architecture illustrated in FIG. 2, and other architectures may be equally used without departing from the scope of the disclosed embodiments.

The various elements shown in FIG. 2 can be implemented in hardware, software, or any combination thereof. Specifically, each, some, or all of the hardware elements may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), tensor processing units (TPUs), graphics processing unit (GPUs), and the like, or any other hardware logic components that can perform calculations or other manipulations of information.

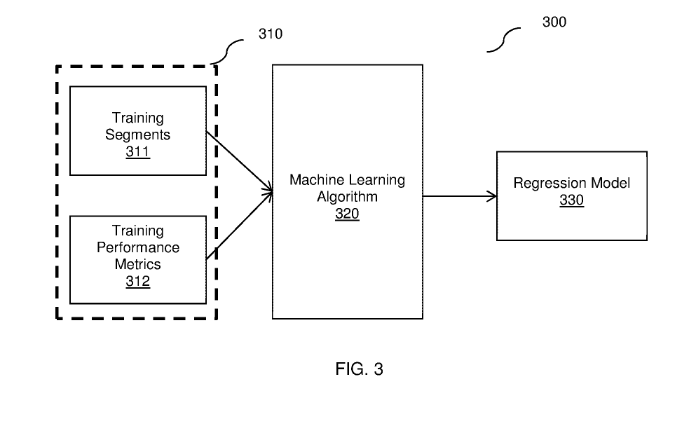

FIG. 3 shows a flow diagram 300 illustrating training a regression model according to an embodiment. A training set 310 is fed to a machine learning algorithm 320 to generate a regression model 330.

The training set 310 includes sequences of training inputs such as training segments 311 and training performance metrics 312. The training segments 311 include dimensions and corresponding values of performance data as described herein above. The training performance metrics 312 may include key performance indicators (KPIs) such as, but not limited to, click-through rate (CTR), cost per acquisition (CPA), bounce rate, qualified leads rate, and the like. The training performance metrics 312 may be determined based on performance and volume measurements such as, but is not limited to, numbers of clicks, numbers of impressions, cost, numbers of bounces, number of platforms on which the content was published, number of websites on which the content was published, and the like.

The machine learning algorithm 320 is configured to output the regression model 330. The regression model 330 may provide predicted performance metric values based on input segments or combinations of segments. In an embodiment, the machine learning algorithm 320 may be configured to perform random forest regression modeling to fit a forest to the training segments 311 and performance metrics 312. The resulting regression model 330 may include feature importance values representing the degree to which each segment affects the corresponding performance metric.

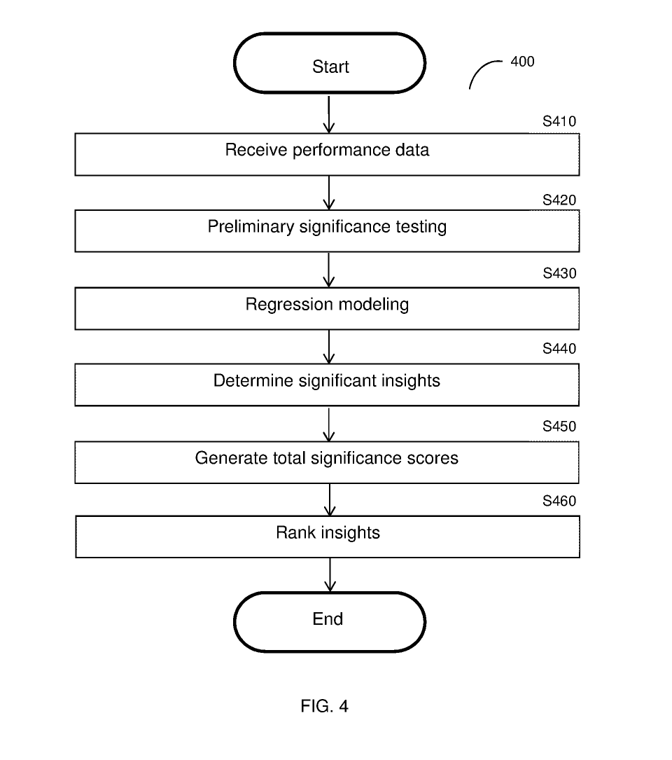

FIG. 4 is a flowchart 400 illustrating a method for providing performance insights according to an embodiment.

At S410, performance data is received or retrieved. The performance data includes at least segments and corresponding performance metrics. Each performance metric is a resulting performance metric that occurred when the corresponding segment was utilized. In an embodiment, S410 further includes generating insights, where each insight includes a segment and a corresponding performance metric such that each insight represents a relationship between the segment and the corresponding performance metric.

At S420, preliminary statistical significance testing is performed. Based on the preliminary statistical significance testing, some insignificant insights may be filtered out. In an embodiment, the preliminary significance testing includes determining a statistical significance score for each insight. Insights having statistical significance scores below a predetermined statistical significance threshold may be filtered out.

The statistical significance scores may be computed using methods such as, for example but not limited to, a ‘t Test’ on a cox box transformation of performance metric values, bootstrapping, an exact binomial test (e.g., for bernoullian performance metric), a combination thereof, and the like. In some implementations, the computation of statistical significance scores may be performed in stages ordered from “easiest” to “hardest,” e.g., from lowest number of computations or amount of time to highest. Filtering may be performed after each stage, where different thresholds may be utilized at different stages. Filtering after each stage may reduce computation time associated with re-computing statistical significance scores using different methods, thereby increasing efficiency of the preliminary significance testing.

At S430, regression modeling is performed, and a predictive score is generated for each insight. The predictive score for an insight represents the predictive power of the insight, i.e., a degree to which the segment of the insight is correlated with the corresponding performance metric.

In an embodiment, S430 includes training a regression model using a training set, and filtering the insights based on the regression model. The predictive scores may be generated based on the regression model, for example, based on feature importance measurements of the regression model. The training set includes segments of the remaining insights as well as their corresponding performance metrics. Insights having importance within the regression model below a predetermined regression importance threshold may be filtered out. In a further embodiment, S430 may further include extracting features to be used for the regression modeling from the insights.

In an embodiment, S430 includes random forest regression modeling, where a forest is fit to the training set. The random forest regression model includes a feature importance measurement for each insight, i.e., for each segment with respect to its corresponding performance metric. The insights may be filtered with respect to the predictive scores generated based on the feature importance measurements. In an example implementation, the top “X” insights may be selected, where “X” is a predetermined positive integer number of insights, and the top “X” insights includes segments having the “X” highest feature importance measurements. Other insights (i.e., insights other than the top “X” insights) may be filtered out.

At 440, significant insights are determined. In an embodiment, the significant insights include all insights which were not filtered out at S420 or S430.

At S450, a total significance score is generated for each significant insight. In an embodiment, each total significance score is generated based on the predictive score, a performance metric effect size, a magnitude, and the statistical significance score for the respective insight. Accordingly, each total significance score is a multi-faceted representation of the effect of the segment of an insight on the corresponding performance metric.

In an embodiment, S450 may further include determining the performance metric effect size, magnitude, scaled statistical significance score, or a combination thereof, for each significant insight.

At S460, based on the total significance scores, the significant insights are ranked. The insights may be ranked, for example, in order from highest total significance score to lowest total significance score. In an embodiment, S460 may include generating a notification indicating the rankings of the insights. The notification may be sent to, for example, a user device (e.g., a tablet computer of an advertiser).

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for providing significant performance insights on marketing campaign data, comprising:
training a regression model using a training set including segments and corresponding performance metrics of a plurality of potentially significant insights, each segment being a combination of a dimension and a value, wherein each insight includes a segment and a corresponding performance metric;
filtering, based on the regression model, at least one insight from the plurality of potentially significant insights to result in at least one significant insight;
computing, based in part on the regression model, a total significance score for each of the at least one significant insight; and
ranking the at least one significant insight based on the computed total significance scores.

2. The method of claim 1, further comprising:
determining at least one statistical significance score for each of a plurality of insights; and
filtering, based on the determined statistical significance scores, at least one insight from the plurality of insights to result in a plurality of potentially significant insights.

3. The method of claim 2, wherein determining the at least one statistical significance score for each insight includes at least two stages, wherein a different statistical significance score is determined for each insight at each stage, wherein the insights are recursively filtered after each stage.

4. The method of claim 3, wherein each stage includes any of: a t-test, bootstrapping, and an exact binomial test.

5. The method of claim 1, wherein the regression model is a random forest regression model including a feature importance measurement for each insight, wherein the potentially significant insights are filtered based on the feature importance measurements of the regression model.

6. The method of claim 1, wherein the regression model is trained using the segments as independent variables and the corresponding performance metrics as a dependent variable.

7. The method of claim 1, wherein the filtering based on the regression model further comprises:
determining, based on the regression model, a predictive score for each segment with respect to the corresponding performance metric, wherein insights including segments having predictive scores below a predetermined threshold are filtered out.

8. The method of claim 7, wherein the regression model includes a plurality of feature importance values, wherein the predictive scores are determined based on the feature importance values.

9. The method of claim 7, wherein each total significance score is computed based on an effect size, a magnitude, the predictive score, and a scaled statistical significance score for one of the at least one significant insight.

10. A non-transitory computer readable medium having stored thereon instructions for causing a processing circuitry to execute a process, the process comprising:
training a regression model using a training set including segments and corresponding performance metrics of a plurality of potentially significant insights, each segment being a combination of a dimension and a value, wherein each insight includes a segment and a corresponding performance metric;
filtering, based on the regression model, at least one insight from the plurality of potentially significant insights to result in at least one significant insight;
computing, based in part on the regression model, a total significance score for each of the at least one significant insight; and
ranking the at least one significant insight based on the computed total significance scores.

11. A system for providing significant performance insights on marketing campaign data, comprising:
a processing circuitry; and
a memory, the memory containing instructions that, when executed by the processing circuitry, configure the system to:
train a regression model using a training set including segments and corresponding performance metrics of a plurality of potentially significant insights, each segment being a combination of a dimension and a value, wherein each insight includes a segment and a corresponding performance metric;
filter, based on the regression model, at least one insight from the plurality of potentially significant insights to result in at least one significant insight;
compute, based in part on the regression model, a total significance score for each of the at least one significant insight; and
rank the at least one significant insight based on the computed total significance scores.

12. The system of claim 11, wherein the system is further configured to:
determine at least one statistical significance score for each of a plurality of insights; and
filter, based on the determined statistical significance scores, at least one insight from the plurality of insights to result in a plurality of potentially significant insights.

13. The system of claim 12, wherein determining the at least one statistical significance score for each insight includes at least two stages, wherein a different statistical significance score is determined for each insight at each stage, wherein the insights are recursively filtered after each stage.

14. The system of claim 13, wherein each stage includes any of: a t-test, bootstrapping, and an exact binomial test.

15. The system of claim 11, wherein the regression model is a random forest regression model including a feature importance measurement for each insight, wherein the potentially significant insights are filtered based on the feature importance measurements of the regression model.

16. The system of claim 11, wherein the regression model is trained using the segments as independent variables and the corresponding performance metrics as a dependent variable.

17. The system of claim 11, wherein the system is further configured to:
determine, based on the regression model, a predictive score for each segment with respect to the corresponding performance metric, wherein insights including segments having predictive scores below a predetermined threshold are filtered out.

18. The system of claim 17, wherein the regression model includes a plurality of feature importance values, wherein the predictive scores are determined based on the feature importance values.

19. The system of claim 17, wherein each total significance score is computed based on an effect size, a magnitude, the predictive score, and a scaled statistical significance score for one of the at least one significant insight.
